(19) United States
(12) Patent Application Publication
(10) Pub. No.: US 2018/0305879 A1
(43) Pub. Date: Oct. 25, 2018

(54) WINTER SERVICE VEHICLE AND METHODS FOR DETERMINING A SPREADING RATE FOR SPREADING DE-ICING MATERIAL ON ROADS

(71) Applicant: ENGRENAGE PROVINCIAL INC., Quebec (CA)

(72) Inventor: Martin GRENIER, Quebec (CA)

(21) Appl. No.: 15/873,338

(22) Filed: Jan. 17, 2018

Related U.S. Application Data
(60) Provisional application No. 62/488,321, filed on Apr. 21, 2017.

(51) Int. Cl. E01H 10/00; G05D 7/06; G05B 15/02

(52) U.S. Cl. CPC E01H 10/007; H04L 2012/40215; G05B 15/02; G05D 7/0605

(57) ABSTRACT

The winter service vehicle generally has a chassis, an engine mounted to the chassis, an engine control unit (ECU), a spreading system mounted to the chassis, and a computer. The winter service vehicle further comprises a controller area network (CAN) bus link connected between the ECU and the computer, allowing the computer to determine a current speed of the winter service vehicle via the CAN bus link, and to determine a spreading rate based on the current speed of the winter service vehicle. The spreading rate is the rate at which de-icing material is spread on roads by the spreading system of the winter service vehicle.

### FIELD

The improvements generally relate to winter service vehicles and more specifically to winter service vehicles including spreading systems for spreading de-icing material such as salt, sand and/or the like on the roads during winter for de-icing purposes.

### BACKGROUND

Winter service vehicles are generally used to remove snow and ice from the roads during winter. A typical winter service vehicle includes a spreading system for receiving, carrying and spreading the de-icing material on the roads.

It is known to vary a spreading rate at which the de-icing material is spread on the roads as a function of a speed of the winter service vehicle. Indeed, for a same amount of de-icing material to be spread on a given length of road, a winter service vehicle traveling at a higher speed will need to spread the de-icing material at a spreading rate greater than a spreading rate of a winter service vehicle traveling at a lower speed.

Knowing the speed of the winter service vehicle with accuracy helps determining a satisfactory spreading rate. As can be understood, under spreading may lead to inadequate de-icing while over spreading may lead to unnecessary material costs.

Conventional ways to determine the speed of the winter service vehicle typically involve the use of an optical speed sensor pointed at the road or the use of a global positioning system (GPS) sensor. Although the conventional winter service vehicles are satisfactory to a certain extent, dirt obstructing a field of view of the optical speed sensor or GPS drifts associated with GPS sensors can limit the accuracy of the measurement of the speed of the winter service vehicle and, in turn, limit the accuracy of the spreading rate. There thus remains room for improvement.

### SUMMARY

This disclosure relates to determining the speed of the winter service vehicle from an engine control unit (ECU) of the winter service vehicle via a controller area network (CAN) bus connection. Such CAN bus connection can be established by connecting a CAN bus link to a diagnostic CAN bus port of the ECU. Proceeding accordingly was found satisfactory as the speed of the winter service vehicle can be determined in an accurate and systematic manner, even in difficult weather conditions.

In accordance with one aspect, there is provided a winter service vehicle having a chassis, an engine mounted to the chassis, an ECU, a spreading system mounted to the chassis, and a computer, the winter service vehicle further comprising: a CAN bus link connected between the ECU and the computer; the computer being configured to: determining a current speed of the winter service vehicle via the CAN bus link; and determining a spreading rate of the spreading system based on the current speed of the winter service vehicle, the spreading rate being the rate at which de-icing material is spread on roads by the spreading system.

In accordance with another aspect, there is provided a computer-implemented method for determining a spreading rate at which de-icing material is spread on roads by a winter service vehicle having a chassis, an engine mounted to the chassis, an ECU, a spreading system mounted to the chassis, and a computer, the method comprising: establishing a CAN bus connection between the ECU and the computer; determining a current speed of the winter service vehicle using the CAN bus connection; and determining the spreading rate based on the current speed of the winter service vehicle.

In accordance with another aspect, there is provided a method for determining a spreading rate at which de-icing material is spread on roads by a winter service vehicle having a chassis, an engine mounted to the chassis, an ECU, a spreading system mounted to the chassis, and a computer, the method comprising: connecting a CAN bus link between the ECU and the computer; using the computer, determining a current speed of the winter service vehicle using the CAN bus link; and determining the spreading rate based on the current speed of the winter service vehicle; and spreading de-icing material on roads at the determined spreading rate using the spreading system.

Many further features and combinations thereof concerning the present improvements will appear to those skilled in the art following a reading of the instant disclosure.

### DESCRIPTION OF THE FIGURES

In the figures,

FIG. 1 is a side elevation view of an example of winter service vehicle, in accordance with an embodiment;

FIG. 2 is an enlarged partial view of an ECU of the winter service vehicle of FIG. 1, showing a CAN bus link connected to a diagnostic CAN bus port of the ECU, in accordance with an embodiment; and

FIG. 3 is a graph showing a CAN bus signal over time, in accordance with an embodiment.

### DETAILED DESCRIPTION

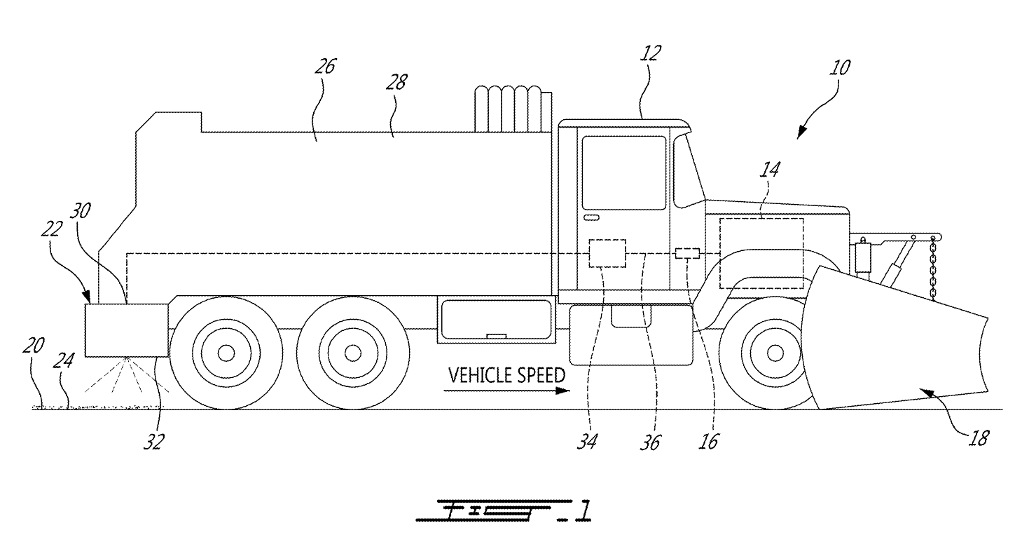

FIG. 1 shows an example of a winter service vehicle 10. In this example, the winter service vehicle 10 has a truck chassis 12. In some embodiments, the truck chassis 12 can be a dump truck chassis.

As shown, the winter service vehicle 10 has an engine 14 mounted to the truck chassis 12. More specifically, in this embodiment, the engine 14 is a diesel engine which can power the winter service vehicle 10 in a manner allowing the winter service vehicle 10 to accelerate to and maintain a given speed during use. The winter service vehicle 10 has an engine control unit (ECU) 16 or engine control module (ECM) which is in communication with the engine 14 for controlling one or more of its electrical systems or subsystems to ensure optimal performance of the engine 14.

In this example, the winter service vehicle 10 has a snow removal equipment or a snowplow 18 mounted in a front portion of the truck chassis 12. In this way, the winter service vehicle 10 can be used for removing snow and ice from outdoor surfaces such as road 20.

The winter service vehicle 10 has a spreading system 22 mounted to the truck chassis 12. The spreading system 22 is used for receiving, carrying and spreading de-icing material 24 on the road 20 for de-icing purposes. The de-icing material 24 can be provided in the form of particulate material, liquid material, or a combination of both. Examples of de-icing material 24 commonly used for de-icing road 20 includes salt (e.g., rock salt), sand and/or gravel. However, any type of de-icing material 24 can be used including calcium chloride, magnesium chloride, potassium chloride, calcium magnesium acetate, potassium formate, sodium formate, calcium formate and/or urea.

In this embodiment, the spreading system 22 includes a hopper 26 with an upwardly facing end 28 for receiving the de-icing material 24 and a downwardly facing discharging end 30 for discharging the de-icing material 24 as desired.

As shown, the discharging end 30 of the truck chassis 12 is located at a rear portion of the truck chassis 12. In this specific embodiment, the spreading system 22 has an impeller 32 provided at the discharging end 30 for spreading the de-icing material 24 on the road 20 in a manner allowing to control a rate at which the de-icing material 24 is spread on the road 20, i.e. the spreading rate. In some embodiment, a rotation speed of the impeller 32 is increased when the spreading rate of the de-icing material 24 is to be increased.

The winter service vehicle 10 has a computer 34 which is communicatively coupled to the spreading system 22. The computer 34 is adapted and configured to control the spreading rate of the spreading system 22. For instance, the computer 34 can transmit instructions to the spreading system 22 which can increase, maintain or decrease a current spreading rate of the spreading system 22.

The winter service vehicle 10 has a controller area network (CAN) bus link 36 which is connected between the ECU 16 and the computer 34 so as to establish a CAN bus connection between the ECU 16 and the computer 34. In this way, the computer 34 can determine a current speed of the winter service vehicle 10 via the CAN bus link 36 and then determine the spreading rate based on the previously determined current speed of the winter service vehicle 10. Accordingly, the spreading system 22 can spread the de-icing material 24 on the road 20 at the determined spreading rate.

As can be understood, in this embodiment, the CAN bus link 36 allows communication according to the SAE J1939 standard protocol maintained by SAE International. However, in some other embodiments, it is envisaged that the CAN bus link 36 can allow communication according to any type of communication protocol of the ECU, including for instance the SAE J1708 standard protocol maintained by SAE International and/or the CANopen protocol.

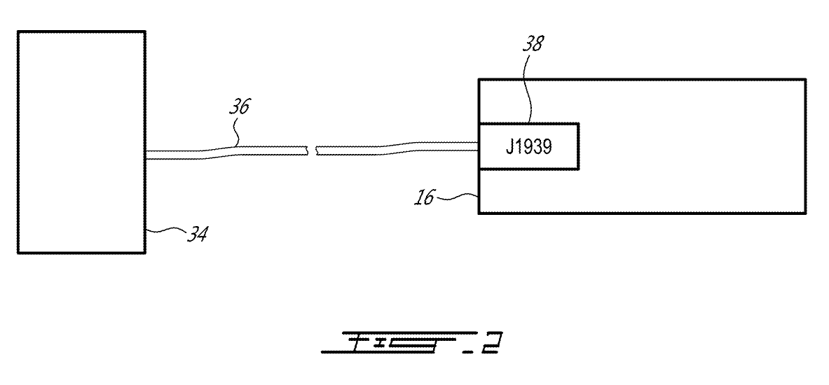

As best seen in the embodiment of FIG. 2, the CAN bus link 36 includes a wired connection between a diagnostic CAN bus port 38 of the ECU 16 and the computer 34. In this specific embodiment, the engine 14 is a diesel engine so the diagnostic CAN bus port 38 is a J1939 port.

In some embodiments, the computer 34 is configured to perform the step of determining the current speed of the winter service vehicle 10 and the step of determining the spreading rate based on the most previously determined current speed of the winter service vehicle 10 in a repeated manner to ensure that an ideal spreading rate is used at all times during operation of the winter service vehicle 10. For instance, these steps of determining can be repeated at a frequency higher than 10 Hz, preferably higher than 100 Hz, and most preferably higher than 500 Hz.

The CAN bus link 36 allows communication of messages or frames between the ECU 16 and the computer 34. In some embodiments, the computer 34 receives a CAN bus signal comprising a series of frames and can retrieve the current speed of the winter service vehicle 10 from one or more of the frames of the CAN bus signal.

A CAN bus signal can have one of four frame types: i) a data frame containing data for transmission, ii) a remote frame requesting the transmission of a specific identifier, iii) an error frame transmitted indicating an error, iv) an overload frame injecting a delay between data and/or remote frames.

In some embodiments, the ECU 16 can transmit frames on an autonomous basis so that the computer 34 can receive a data frame concerning the current speed of the winter service vehicle 10 periodically. In some other embodiments, the computer 34 is configured to transmit a remote frame requesting the transmission of a specific identifier concerning the current speed of the winter service vehicle 10. In these embodiments, the computer 34 receives the data frame concerning the current speed of the winter service vehicle 10 shortly after the remote frame is transmitted.

The frame can have differing types of standardized formats. For instance, the frame format can be a standard frame format as described in CAN 2.0 A and/or CAN 2.0 B or can alternatively be the extended frame format as described in CAN 2.0 B. One difference between the two formats is that the “CAN base frame” supports a length of 11 bits for the identifier, and the “CAN extended frame” supports a length of 29 bits for the identifier, made up of the 11-bit identifier (“base identifier”) and an 18-bit extension (“identifier extension”). A distinction between CAN base frame format and CAN extended frame format can be made by using the IDE bit, which is transmitted as dominant in case of an 11-bit frame, and transmitted as recessive in case of a 29-bit frame. The computer 34 can be configured to support any of the standard frame formats and/or the extended frame format.

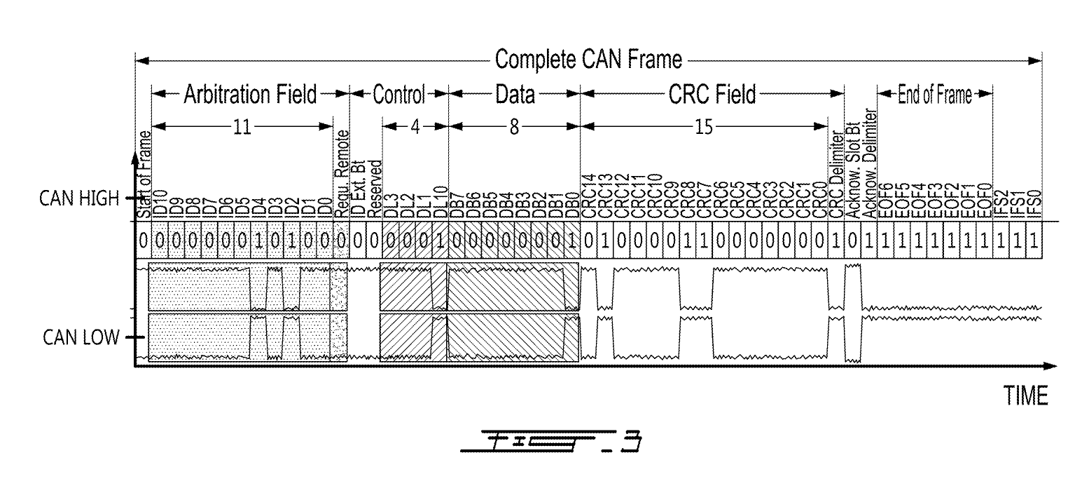

FIG. 3 shows an example of a data frame having the base frame format. As shown in this example, the data frame has: a start-of-frame field having one bit and denoting the start of frame transmission; an identifier field having 11 bits which identifies and indicates the message priority; a remote transmission request (RTR) field having 1 bit which is dominant (bit=0) for data frames and recessive (bit=1) for remote request frames; one identifier extension (IDE) field having one bit which is dominant (bit=0) for base frame format with 11-bit identifiers; a reserved bit (r0) field having 1 bit which must be dominant (bit=0) but accepted as either dominant or recessive; a data length code (DLC) field having 4 bits and which has a number of bytes of data (0-8 bytes); a data field having 0-64 bits (0-8 bytes) for communicating data; a cyclic redundancy check (CRC) field comprising 15 bits; a CRC delimiter field having one bit and which must be recessive (bit=1); an acknowledgement (ACK) slot field having 1 bit and which transmitter sends recessive (bit=1) and any receiver can assert a dominant (bit=0); an ACK identifier field having one bit which must be recessive (bit=1); and an end-of-frame field having 7 bits and which must be recessive (bit=1).

In this embodiment, upon receiving a series of frames, the computer 34 can determine the speed of the winter service vehicle 10 by reading the data field of a frame having an identifier corresponding to the speed of the winter service vehicle 10. For instance, the identifier corresponding to the speed of the winter service vehicle 10 can be the number “45”. Accordingly, the computer 34 can determine the current speed of the winter service vehicle 10 by reading the data field of any frame having the number “45” in the identifier field. Similarly, the computer 34 can also be configured to send a remote frame to the ECU 16 requesting the data frame having the number “45” in the identifier field.

It will be understood that the expression “computer” as used herein is not to be interpreted in a limiting manner. It is rather used in a broad sense to generally refer to the combination of some form of one or more processing units and some form of memory system accessible by the processing unit(s). The computer 34 can be a microcontroller, a personal computer, a smart phone, an appliance computer, etc.

It will be understood that the various functions of the computer 34, or more specifically of the processing unit or of the memory controller, can be performed by hardware, by software, or by a combination of both. For example, hardware can include logic gates included as part of a silicon chip of the processor. Software can be in the form of data such as computer-readable instructions stored in the memory system. With respect to a computer, a processing unit, a memory controller, or a processor chip, the expression “configured to” relates to the presence of hardware, software, or a combination of hardware and software which is operable to perform the associated functions.

In some embodiments, the computer 34 is located in a cabin of the winter service vehicle 10 and is accessible to the driver. In these embodiments, the computer 34 has a user interface such as a touchscreen, a display, a keyboard, or a combination thereof allowing the driver to interact with the computer 34. The computer 34 can thus be configured to receive user input such as a desired amount of de-icing material per unit length to be spread on the road 20. In this case, the computer 34 can determine the spreading rate based on the current speed of the winter service vehicle in addition to the desired amount of per unit length to be spread on the road 20. In alternate embodiments, the computer 34 is in communication with a remote computer or server and receives the desired amount of de-icing material per unit length to be spread on the road from the remote computer or server.

As can be understood, the computer 34 can have a processor, a memory, and I/O interface and other electronic components. Instructions for operating the computer 34 can be stored on the memory and be accessible by the processor.

The processor can be, for example, a general-purpose microprocessor or microcontroller, a digital signal processing (DSP) processor, an integrated circuit, a field programmable gate array (FPGA), a reconfigurable processor, a programmable read-only memory (PROM), or any combination thereof.

The memory can include a suitable combination of any type of computer-readable memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Each I/O interface enables the computer 34 to interconnect with one or more input devices such as the ECU 16 or with one or more output devices such as the ECU 16.

Each network interface enables the computer 34 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. WMAX), SS7 signaling network, fixed line, local area network, wide area network, and others, including any combination of these.

As can be understood, the examples described above and illustrated are intended to be exemplary only. Although the illustrated embodiment shows a winter service vehicle having a truck chassis, it is understood that the winter service vehicle can have any other suitable type of chassis depending on the embodiment. For instance, the winter service vehicle can have a regular vehicle chassis in some embodiments or a dump truck chassis in some other embodiments. Although the winter service vehicle generally has a diesel engine, it is intended that the winter service vehicle can have an electric engine, a gasoline engine or any other suitable engine. The spreading system is not limited to the one described in this disclosure. Indeed, it is intended that the winter service vehicle can have any spreading system which spreading rate can be adjusted in real time or quasi real time. It will be understood that the CAN bus connection between the ECU and the computer can be a wired connection, a wireless connection or a combination of both depending on the circumstances. Moreover, as will be understood, the diagnostic CAN bus port of the ECU can be provided in the form of a J1939 port, a J1708 port or a CANopen port, depending on which type of communication protocol the ECU uses. The scope is indicated by the appended claims.

What is claimed is:

1. A winter service vehicle having a chassis, an engine mounted to the chassis, an engine control unit (ECU), a spreading system mounted to the chassis, and a computer, the winter service vehicle further comprising:
a controller area network (CAN) bus link connected between the ECU and the computer;
the computer being configured to:
determining a current speed of the winter service vehicle via the CAN bus link; and
determining a spreading rate of the spreading system based on the current speed of the winter service vehicle, the spreading rate being the rate at which de-icing material is spread on roads by the spreading system.

2. The winter service vehicle of claim 1 wherein the CAN bus link allows communication according to the SAE J1939 standard protocol.

3. The winter service vehicle of claim 1 wherein the CAN bus link allows communication according to the SAE J1708 standard protocol.

4. The winter service vehicle of claim 1 wherein the CAN bus link includes a wired CAN bus connection between a diagnostic CAN bus port of the ECU and the computer.

5. The winter service vehicle of claim 4 wherein the diagnostic CAN bus port is a J1939 port.

6. A computer-implemented method for determining a spreading rate at which de-icing material is spread on roads by a winter service vehicle having a chassis, an engine mounted to the chassis, an engine control unit (ECU), a spreading system mounted to the chassis, and a computer, the method comprising:
establishing a controller area network (CAN) bus connection between the ECU and the computer;
determining a current speed of the winter service vehicle using the CAN bus connection; and
determining the spreading rate based on the current speed of the winter service vehicle.

7. The computer-implemented method of claim 6 wherein the CAN bus connection allows communication according to the SAE J1939 standard protocol.

8. The computer-implemented method of claim 6 wherein the CAN bus connection allows communication according to the SAE J1708 standard protocol.

9. The computer-implemented method of claim 6 wherein said establishing the CAN bus connection includes receiving a CAN bus signal including a plurality of frames, retrieving a given frame having an identifier associated with the current speed of the winter service vehicle, and wherein said determining the current speed of the winter service vehicle includes reading a data field of the given frame.

10. The computer-implemented method of claim 6 further comprising repeating said steps of determining at a frequency higher than 10 Hz, preferably higher than 100 Hz, and most preferably higher than 500 Hz.

11. The computer-implemented method of claim 6 wherein said establishing the CAN bus connection includes establishing a wired CAN bus connection between the ECU and the computer.

12. The computer-implemented method of claim 11 wherein the CAN bus connection includes a CAN bus link connected between a diagnostic CAN bus port of the ECU and the computer.

13. The computer-implemented method of claim 12 wherein the diagnostic CAN bus port of the ECU is a J1939 port.

14. A method for determining a spreading rate at which de-icing material is spread on roads by a winter service vehicle having a chassis, an engine mounted to the chassis, an engine control unit (ECU), a spreading system mounted to the chassis, and a computer, the method comprising:
connecting a controller area network (CAN) bus link between the ECU and the computer;
using the computer,
determining a current speed of the winter service vehicle using the CAN bus link; and
determining the spreading rate based on the current speed of the winter service vehicle; and
spreading de-icing material on roads at the determined spreading rate using the spreading system.

15. The method of claim 14 wherein the CAN bus link allows communication according to the SAE J1939 standard protocol.

16. The method of claim 14 wherein the CAN bus link allows communication according to the SAE J1708 standard protocol.

17. The method of claim 14 wherein said connecting includes connecting the CAN bus link between a diagnostic CAN BUS link of the ECU and the computer.

18. The method of claim 17 wherein the diagnostic CAN bus link is a J1939 port.
